(19) United States
(12) Patent Application Publication
(10) Pub. No.: US 2012/0126982 A1
(43) Pub. Date: May 24, 2012

(54) ELECTRONIC SHELF LABEL (ESL) APPARATUS USING RADIO FREQUENCY IDENTIFICATION (RFID) AND METHOD FOR OPERATING THE ESL APPARATUS

(75) Inventors: Dong Han LEE, Daejeon (KR); Chan Won Park, Daejeon (KR); Ji Hoon Bae, Daejeon (KR)

(73) Assignee: ELECTRONICS AND TELECOMMUNICATIONS RESEARCH INSTITUTE, Daejeon (KR)

(21) Appl. No.: 13/189,891

(22) Filed: Jul. 25, 2011

(30) Foreign Application Priority Data
Nov. 23, 2010 (KR) 10-2010-0116627

(51) Int. Cl. G08B 13/14

(52) U.S. Cl. 340/572.1

(57) ABSTRACT

Provided are an electronic shelf label (ESL) apparatus using radio frequency identification (RFID) and an operation method of the ESL apparatus. The ESL apparatus may include an ESL tag to be attached to a shelf and a radio tag reader to store, in the ESL tag, details that is received from an ESL server, in response to an article information update request from the ESL server.

### CROSS-REFERENCE TO RELATED APPLICATION

This application claims the benefit of Korean Patent Application No. 10-2010-0116627, filed on Nov. 23, 2010, in the Korean Intellectual Property Office, the disclosure of which is incorporated herein by reference.

### BACKGROUND

1. Field of the Invention

Embodiments of the present invention relate to an electronic shelf label (ESL) apparatus using radio frequency identification (RFID) that may readily read and update details, stored in an ESL tag attached to a shelf, using a radio tag reader included in the shelf, and an operation method of the ESL apparatus.

2. Description of the Related Art

An electronic shelf label (ESL) apparatus may manage details using an ESL tag positioned within a store.

The conventional ESL apparatus is configured based on ZigBee using an infrared ray (IR) scheme, a low frequency band communication, or a radio frequency (RF) band.

FIG. 1 is a diagram illustrating a configuration of a conventional ESL apparatus.

Referring to FIG. 1, the conventional ESL apparatus may include a server 101 being positioned in a center to control an ESL reader 103, an ESL tag 105 being positioned in a store to include details, and the ESL reader 103 to transfer communication between the server 101 and the ESL tag 105.

The conventional ESL apparatus may have a degraded accuracy when reading or updating information of a plurality of ESL tags based on an environment of the store, for example, an obstacle within the store, and may increase a complexity and a cost for infrastructure facilities.

Specifically, to update ESL tag information within the store, for example, to update details, the conventional ESL apparatus may use minimum one reader or antenna to maximum at least tens of readers or antennas based on a radio communication scheme or a frequency difference. Also, when the conventional ESL apparatus employs an IR scheme, a relatively large number of readers may be required, thereby increasing a facility cost and an area where reception is impossible may occur depending on the store environment.

When the conventional ESL apparatus employs an RF scheme, for example, 2.4 GHz of ZigBee, the area where reception is impossible may also occur depending on the store environment. In addition, due to a short battery lifespan, a battery replacement cost may also occur. In this instance, when the conventional ESL apparatus employs a portable radio frequency identification (RFID) terminal of an ultra high frequency (UHF) band, the above problems may be solved. However, to update details in which price information frequently varies, a manager may need to visit the store where an ESL tag is positioned whenever update is required.

### SUMMARY

An aspect of the present invention provides an electronic shelf label (ESL) apparatus using radio frequency identification (RFID) that may store, in an ESL tag attached to a shelf, details, for example, price information that is received from an ESL server, thereby readily updating the details included in the ESL tag, and an operation method of the ESL apparatus.

Another aspect of the present invention provides an ESL apparatus using RFID that may obtain identification information of an article, positioned on a shelf, from an article recognition tag attached to the article, and provide the obtained identification information to an ESL server, thereby enabling a manager to readily perform the inventory of the article and to effectively manage the article and decrease a cost used for managing human resources, and an operation method of the ESL apparatus.

According to an aspect of the present invention, there is provided an ESL apparatus using an RFID, the apparatus including: an ESL tag to be attached to a shelf; and a radio tag reader to store, in the ESL tag, details that is received from an ESL server, in response to an article information update request from the ESL server.

According to another aspect of the present invention, there is provided an operation method of an ESL apparatus using RFID, the method including: receiving details from an ESL server together with an article information update request from the ESL server; storing the received details in an ESL tag attached to a shelf; and displaying the received details.

According to embodiments of the present invention, it is possible to store, in an ESL tag attached to a shelf, details, for example, price information that is received from an ESL server, thereby readily updating the details included in the ESL tag.

According to embodiments of the present invention, it is possible to obtain identification information of an article, positioned on a shelf, from an article recognition tag attached to the article, and to provide the obtained identification information to an ESL server, thereby enabling a manager to readily perform the inventory of the article. Therefore, it is possible to effectively manage the article and decrease a cost used for managing human resources.

According to embodiments of the present invention, when a radio tag reader is included in a shelf, it is possible to decrease an additional cost for installation of a separate radio tag reader and to prevent an area where reception is impossible from occurring.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a configuration of a conventional electronic shelf label (ESL) apparatus;

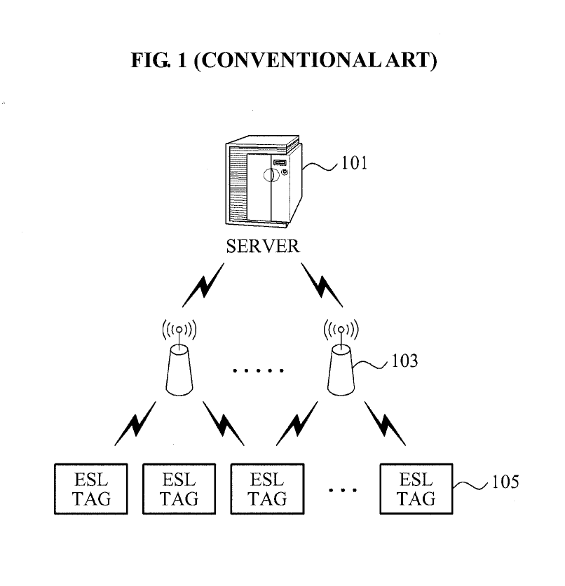

FIG. 2 is a diagram illustrating a configuration of an ESL system using radio frequency identification (RFID) according to an embodiment of the present invention;

FIG. 3 is a block diagram illustrating a configuration of an ESL tag of an ESL apparatus of FIG. 2 using RFID according to an embodiment of the present invention;

FIG. 4 is a configuration of an ESL apparatus using RFID according to another embodiment of the present invention; and

FIG. 5 is a flowchart illustrating an operation method of an ESL apparatus using RFID according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

Hereinafter, an electronic shelf label (ESL) apparatus using radio frequency identification (RFID) and an operation method of the ESL apparatus according to embodiments of the present invention will be described with reference to the accompanying drawings. Here, the ESL apparatus using the RFID may be positioned in, for example, a store. For communication with an ESL server positioned in the center, the ESL apparatus may readily update details included in an ESL tag attached to a shelf, or may provide, to the ESL server, identification information of an article that is attached to the article, thereby effectively performing the inventory of the article in the store.

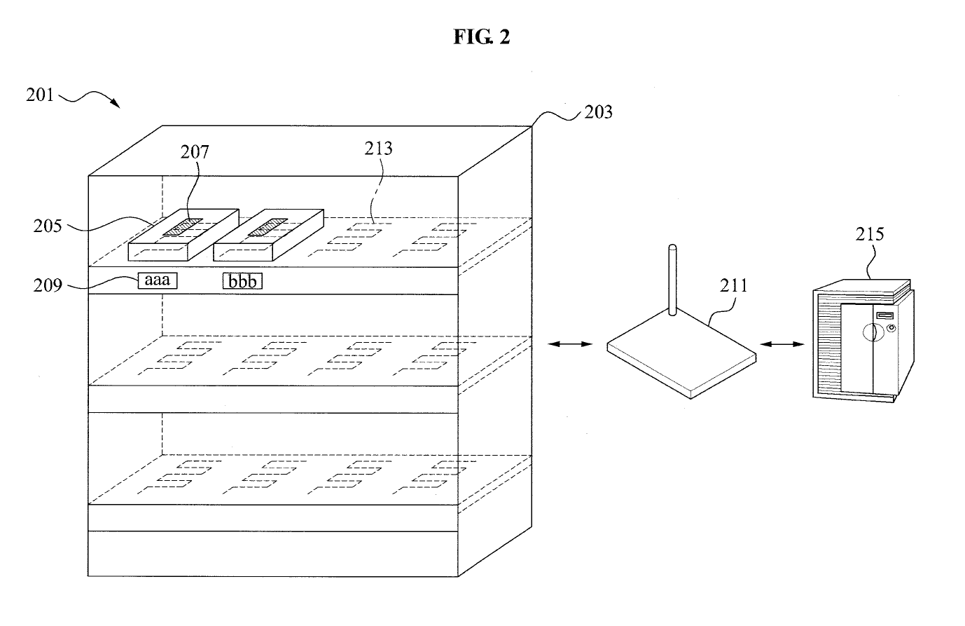

FIG. 2 is a diagram illustrating a configuration of an ESL system using RFID according to an embodiment of the present invention.

Referring to FIG. 2, the ESL system using the RFID may include an ESL apparatus 201 using the RFID and an ESL server 215.

The ESL apparatus 201 may include a shelf 203, an article 205, an article recognition tag 207, an ESL tag 209, a radio tag reader 211, and a radio tag reader antenna 213.

The article 205 may be displayed on the shelf 203. Also, the shelf 203 may include the ESL tag 209 corresponding to the article recognition tag 207 attached to the article 205, the radio tag reader 211, and the radio tag reader antenna 213.

The article recognition tag 207 may be, for example, an RFID tag of an ultra high frequency (UHF) short distance band or long distance band. The article recognition tag 207 may include identification information of the article 205 positioned on the shelf 203 and be attached to the article 205. The article recognition tag 207 may provide identification information of the article 205 to the radio tag reader 211 via the radio tag reader antenna 213 according to control of the radio tag reader 211.

The ESL tag 209 may be, for example, an RFID tag of an ultra high frequency (UHF) short distance band, and may include details associated with the article 205 and be attached to the shelf 203.

Here, the ESL tag 209 may include, as the details, at least one of a name of the article 205, a place of origin thereof, a manufactured date thereof, a constituent material thereof, and price information thereof.

The ESL tag 209 may update details of the article 205 by providing details, included in the ESL tag 209, to the radio tag reader 211 via the radio tag reader antenna 213 according to control of the radio tag reader 211, or by storing details received from the ESL server 215. The ESL tag 209 may display the updated details via a display unit (not shown).

The radio tag reader 211 may be attached to the shelf 203 as, for example, a UHF RFID reader. However, it is only an example and thus, the radio tag reader 211 may be disposed outside the ESL apparatus 201 to communicate with the article recognition tag 207 or the ESL tag 209. The radio tag reader 211 may select one tag between the article recognition tag 207 and the ESL tag 209 using a predetermined command, for example, ‘select’, and may read information of the selected tag or write information in the selected tag.

In response to an inventory request from the ESL server 215, the radio tag reader 211 may obtain identification information of the article 205 from the article recognition tag 207 and transmit the obtained identification information to the ESL server 215. Accordingly, in a remote place, a manager of the ESL server 215 may effectively perform the inventory of a desired article positioned in a store without visiting the store where the ESL apparatus 201 is positioned.

In response to an article information verification request from the ESL server 215, the radio tag reader 211 may obtain details from the ESL tag 209 and transmit the obtained details to the ESL server 215, thereby providing the manager with details of the article 205 that is stored in the ESL tag 209 and is displayed in the store.

Also, in response to an article information update request from the ESL server 215, the radio tag reader 211 may store, in the ESL tag 209, details that is received from the ESL server 215. Here, when details of the article 205 is pre-stored in the ESL tag 209, the radio tag reader 211 may readily update the ESL tag 209 by replacing the pre-stored details with the details received from the ESL server 215.

The radio tag reader 211 may control the article recognition tag 207 or the ESL tag 209 according to a request from the ESL server 215. However, it is only an example and thus, the radio tag reader 211 may control the article recognition tag 207 or the ESL tag 209 by receiving at least one of the article information update request, the inventory request, and the article information verification request, in response to an input of a selection button using a radio tag reader control program.

The ESL server 215 may include information about the article recognition tag 207, the ESL tag 209, and the radio tag reader 211, for example, a tag identifier (ID), a number of tags, and a radio tag reader and an antenna corresponding to each tag. In response to a selection request of the manager, the ESL server 215 may transmit at least one of the article information update request, the inventory request, and the article information verification request to the ESL apparatus 201 using the RFID.

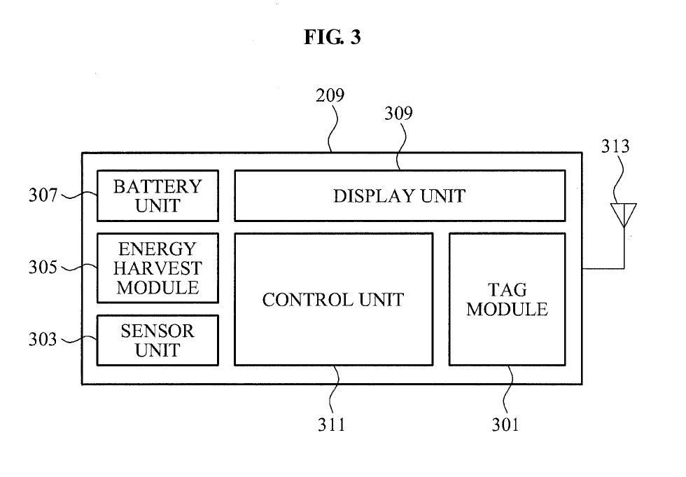

FIG. 3 is a block diagram illustrating a configuration of the ESL tag 209 of the ESL apparatus 201 of FIG. 2 using RFID according to an embodiment of the present invention.

Referring to FIG. 3, the ESL tag 209 may include a tag module 301, a sensor unit 303, an energy harvest module 305, a battery unit 307, a display unit 309, and a control unit 311.

Although not shown in FIG. 3, the tag module 301 may include an analog-to-digital (A/D) converter for UHF passive RFID communication, for example, an International Organization for Standardization (ISO)/International Electrotechnical Commission (IEC) 18000-6c air interface protocol, a memory to store details, and a communication unit to support a radio communication with the radio tag reader 211.

The sensor unit 303 may sense a neighboring state, for example, a temperature and a humidity.

The energy harvest module 305 may harvest light energy, for example, sunlight or fluorescent lamp light within a store or a warehouse and thereby convert the light energy to electrical energy.

The battery unit 307 may be charged with the harvested energy and be replaced with a general battery.

The display unit 309 may be provided in a form of a liquid crystal display (LCD) or an electron ink.

The control unit 311 may control displaying of details or neighboring state information.

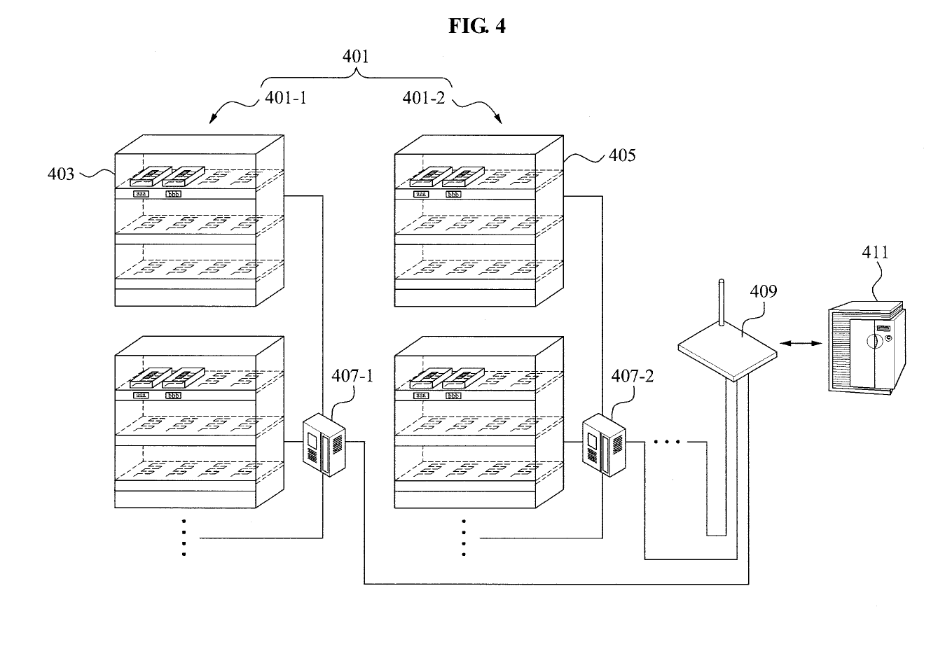

FIG. 4 is a configuration of an ESL apparatus 401 using RFID according to another embodiment of the present invention.

Referring to FIG. 4, an ESL system using the RFID according to another embodiment of the present invention may include the ESL apparatus 401 including n shelves, for example, shelves 401-1 and 401-2, where articles are displayed, m radio switching modules, for example, radio switching modules 407-1 and 407-2, a radio tag reader 409, and an ESL server 411. Here, each of n and m denotes a natural number greater than or equal to 2.

Here, the radio switching modules 407-1 and 407-2 may control switching of communication signals between antennas attached to the n shelves and the radio tag reader 409.

An ESL system using RFID according to another embodiment of the present invention may effectively expand the number of a shelf included in an ESL apparatus using a radio switching module.

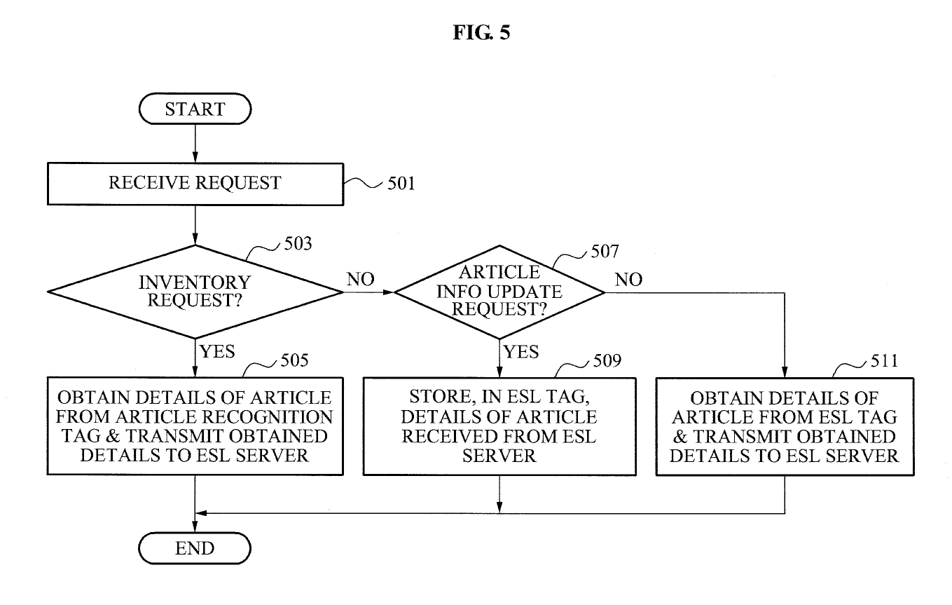

FIG. 5 is a flowchart illustrating an operation method of an ESL apparatus using RFID according to an embodiment of the present invention.

Referring to FIG. 5, in operation 501, the ESL apparatus may receive a request from an ESL server. In this instance, the ESL apparatus may receive the request from the ESL server after a radio tag reader attached to a shelf on which an article is displayed is powered on.

Also, in response to an input of a selection button using a radio tag reader control program, the ESL apparatus may receive at least one of an article information update request, an inventory request, and an article information verification request.

In operation 503, the ESL apparatus may verify whether the request corresponds to the inventory request. When the request corresponds to the inventory request, the ESL apparatus may obtain identification information of an article, positioned on the shelf, from an article recognition tag attached to the article, and may transmit the obtained identification information of the article to the ESL server in operation 505 Here, the ESL apparatus may recognize the article recognition tag using a predetermined command, for example, ‘select’, and may obtain identification information of the article stored in the recognized article recognition tag, using an inventory command and a read command.

The identification information of the article recognition tag including identification information of the article may be distinguished from identification information of the ESL tag including details. For example, the identification information of the article recognition tag may be defined as ‘0000 xxxx xxxx xxxx’ and the identification information of the ESL tag may be defined as ‘1111 xxxx xxxx xxxx’.

Conversely, when the request does not correspond to the inventory request in operation 503, the ESL apparatus may verify whether the request corresponds to the article information update request in operation 507. When the request corresponds to the article information update request, the ESL apparatus may store the received details in the ESL tag including details, together with the article information update request from the ESL server, and may display the stored details using a display unit in operation 509. In this instance, when details of the article is pre-stored in the ESL tag, the ESL apparatus may readily update the ESL tag by replacing the pre-stored details with the received details.

Here, the ESL apparatus using RFID may recognize the ESL tag using a predetermined command, for example, ‘select, and may store the received details in the recognized ESL tag using an inventory command a write command.

The ESL apparatus may receive, as the details from the ESL server, at least one of a name of an article positioned on the shelf, a place of origin of the article, a manufactured date thereof, a constituent material thereof, and price information thereof.

Conversely, when the request does not correspond to the article information update request in operation 507, the ESL apparatus may verify the request as the article information verification request and thereby obtain details from the ESL tag and transmit the details to the ESL server. Here, the ESL apparatus may recognize the ESL tag using a predetermined command, for example, ‘select’, and may obtain details from the recognized ESL tag using an inventory command and a read command.

According to embodiments of the present invention, it is possible to store, in an ESL tag attached to a shelf, details, for example, price information that is received from an ESL server, thereby readily updating the details included in the ESL tag.

According to embodiments of the present invention, it is possible to obtain identification information of an article, positioned on a shelf, from an article recognition tag attached to the article, and to provide the obtained identification information to an ESL server, thereby enabling a manager to readily perform the inventory of the article. Therefore, it is possible to effectively manage the article and decrease a cost used for managing human resources.

According to embodiments of the present invention, when a radio tag reader is included in a shelf, it is possible to decrease an additional cost for installation of a separate radio tag reader and to prevent an area where reception is impossible from occurring.

The above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVDs; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. An electronic shelf label (ESL) apparatus using radio frequency identification (RFID), the apparatus comprising:
an ESL tag to be attached to a shelf; and
a radio tag reader to store, in the ESL tag, details that is received from an ESL server, in response to an article information update request from the ESL server,

2. The apparatus of claim 1, wherein:
the details is associated with an article positioned on the shelf, and
when details of the article is pre-stored in the ESL tag, the radio tag reader updates the ESL tag by replacing the pre-stored details with the details received from the ESL server.

3. The apparatus of claim 1, further comprising:
an article recognition tag comprising identification information of an article positioned on the shelf and to be attached to the article,
wherein in response to an inventory request from the ESL server, the radio tag reader obtains identification information of the article from the article recognition tag and transmits the obtained identification information of the article to the ESL server.

4. The apparatus of claim 1, wherein in response to an article information verification request from the ESL server, the radio tag reader obtains the details from the article shelf label tag and transmits the obtained details to the ESL server.

5. The apparatus of claim 1, further comprising:
a radio switching module to control switching of n communication signals between antennas attached to n shelves and the radio tag reader when the number of shelves is n, where n denotes a natural number of 2 or more.

6. The apparatus of claim 1, wherein the ESL tag comprises:
a communication unit to support a radio communication with the radio tag reader;
a memory to store the details; and
a control unit to control displaying of the details.

7. The apparatus of claim 1, wherein the ESL tag comprises, as the details, at least one of a name of an article positioned on the shelf, a place of origin of the article, a manufactured date thereof, a constituent material thereof, and price information thereof.

8. The apparatus of claim 1, wherein in response to an input of a selection button using a radio tag reader control program, the radio tag reader receives at least one of the article information update request, an inventory request, and an article information verification request.

9. An operation method of an electronic shelf label (ESL) apparatus using radio frequency identification (RFID), the method comprising:
receiving details from an ESL server together with an article information update request from the ESL server;
storing the received details in an ESL tag attached to a shelf; and
displaying the received details.

10. The method of claim 9, wherein:
the details is associated with an article positioned on the shelf, and
the storing comprises updating the ESL tag by replacing pre-stored details of the article with the details received from the ESL server, when the details of the article is pre-stored in the ESL tag.

11. The method of claim 9, further comprising:
in response to an inventory request from the ESL server, obtaining identification information of an article, positioned on the shelf, from an article recognition tag attached to the article, to transmit the obtained identification information of the article to the ESL server.

12. The method of claim 9, further comprising:
in response to an article information verification request from the ESL server, obtaining the details from the article shelf label tag to transmit the obtained details to the ESL server.

13. The method of claim 9, wherein the receiving comprises receiving, as the details from the ESL server, at least one of a name of an article positioned on the shelf, a place of origin of the article, a manufactured date thereof, a constituent material thereof, and price information thereof.

14. The method of claim 9, further comprising:
in response to an input of a selection button using a radio tag reader control program, receiving at least one of the article information update request, an inventory request, and an article information verification request.
